(19) United States
(12) Patent Application Publication
(10) Pub. No.: US 2016/0086117 A1
(43) Pub. Date: Mar. 24, 2016

(54) METHOD AND SYSTEM FOR GEOGRAPHICALLY BASED SOCIAL NEWS GATHERING AND REPORTING

(71) Applicant: Vocativ Ltd., Yakum (IL)

(72) Inventors: Gitit Poran Greenberg, Kochav Yair (IL); Yehonatan Steinmetz, Ashdod (IL)

(21) Appl. No.: 14/859,307

(22) Filed: Sep. 20, 2015

Related U.S. Application Data
(60) Provisional application No. 62/052,578, filed on Sep. 19, 2014.

(51) Int. Cl. G06Q 10/06; H04L 29/08; G06Q 50/00

(52) U.S. Cl. CPC G06Q 10/06311; G06Q 50/01; H04L 67/18

(57) ABSTRACT

Methods and systems for gathering and publishing news are described. Such methods and systems are geographically and social interactive based, and include assigning a beat, performing source development around these beats, defining a coverage map for monitoring the source, creating a coverage plan of the beat and the coverage map, receiving data from robots, where the robots monitor the sources within the coverage map and gather news data according to the coverage plan, using tools to analyze the data and create leads, screen the leads according to the coverage plan, write a journalistic story based on the screened leads; and publish the story. Publication is performed in an on-line medium.

### CROSS REFERENCE TO RELATED APPLICATIONS

This application claims the benefit of U.S. provisional Application No. 62/052,578 filed on Sep. 19, 2014 which is hereby incorporated by reference in their entirety.

### FIELD OF THE INVENTION

The invention relates generally to systems and methods for news gathering. Specifically, the invention relates to use of geographically based surveillance and reporting of current social news.

### BACKGROUND OF THE INVENTION

News agencies may use a mostly top-down approach to coverage, in which editors may be framing and forming news coverage by keeping themselves up to date. They may work with journalists to decide which stories to cover and how to cover them. Journalists may then perform research on specific topics requested. In many cases such an approach may be biased, since journalists may be looking for something specific. For example, if editors decide to cover an Ebola outbreak, journalists may call hospitals, get in touch with patients and doctors, run on-line search queries on “Ebola” and other related keywords and perform other tasks, in order to create that particular story, arising from such an initial tasking.

### SUMMARY OF THE INVENTION

A bottom-up approach to news gathering and reporting is developed, which is unique. Areas or geographic regions are covered instead of specific topics. Such a method may allow a system and/or analysts to generate ideas instead of, for example from editors, therefore unique angles, stories and story angles may be covered. Instead of an editor directing to cover, for example an Ebola virus outbreak, geographic regions and/or multiple geographic regions, e.g. New York and Atlanta, may be covered, and they may be monitored for when people may be starting to talk about the topic.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts an exemplary method according to an embodiment of the present invention;

FIG. 2 depicts an exemplary diagram according to embodiments of the present invention;

FIG. 3 depicts an exemplary diagram according to embodiments of the present invention;

FIG. 4 depicts an exemplary diagram according to embodiments of the present invention;

FIG. 5 depicts an exemplary diagram according to embodiments of the present invention;

FIG. 6 depicts an exemplary diagram according to embodiments of the present invention;

FIG. 7 depicts an exemplary diagram according to embodiments of the present invention;

FIG. 8 depicts an exemplary diagram according to embodiments of the present invention;

FIG. 9 depicts an exemplary diagram according to embodiments of the present invention;

FIG. 10 depicts an exemplary diagram according to embodiments of the present invention;

FIG. 11 depicts an exemplary diagram according to embodiments of the present invention; and

FIG. 12 depicts an exemplary diagram illustrating components according to embodiments of the present invention.

Embodiments of the invention are illustrated by way of example and not limitation in the figures of the accompanying drawings, in which like reference numerals indicate corresponding, analogous or similar elements. It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A new media outlet combines witty, young, straightforward storytelling with deep web analysis. Such a media outlet may be called Vocativ. Deep web specialists, or Sensing Analysts (SA) may be working together with journalists to deliver newsworthy reporting from the deep web. The deep web may be characterized as elements of the Internet that may not be characterized or cataloged by traditional search engines, e.g. Google, or may describe other elements of the Internet that may be otherwise obscure.

A newsroom may be pivoted around Sensing Analysts (SA). Such SAs may be an integral part of a system and general process, and may support a newsroom, for example, with leads to new stories (e.g. bottom-up approach) and different angles on on-going stories (e.g. top-down approach).

Some embodiments use a bottom-up approach, for example which may be unique, e.g. to Vocativ.

Interfaces

In an embodiment, there may be, for example, four main interfaces in a process for geographically based and socially interactive news gathering and publishing. There may be an interface among a Sensing Analyst (SA) and an Editor, where new leads may be pitched, and work may be performed on a next iteration of a lead. There may be an interface among an SA and a Journalist, where work may be done on a storyline, a story may be supported with evidence, and there may be joint accountability and recognition for the story. There may be an interface among an SA and Other functions, where supporting objects for a story may be created. There may be an interface among an SA, for example an SA team lead, and an Editor, where, there may be building of beats and approval of coverage plans. There may be an interface among an SA team lead and an SA, where there may be strategizing of coverage plans, approval of coverage plans and support throughout the process. There may be an interface among a Strategic planner and an Editor, where there may be strategizing of coverage plans and updating on new topics, trends, events, areas, etc.

In an embodiment, products may be text stories, data stories, video stories, online data tools, e.g. dynamic index and/or other products.

According to an embodiment, there may be roles introduced within or by a process. There may be a Sensing Analyst (SA). An SA may be a web intelligence and/or language/domain expert, responsible for mining the deep web using an appropriate data mining tool, e.g. Verne, and using web-based intelligence methodology in order to find story leads and/or provide alerts based on new trends and/or phenomena for each beat. There may be an SA team lead, who may be a web intelligence expert, and responsible for managing and leading a deep web investigative processes and/or overseeing all beats. There may be personnel for Content strategy and innovation, who may be responsible for identifying deep web value for strategic coverage and/or special coverage, and may perform strategic planning that may fall outside of periodic or daily coverage plans, in order to spot areas and topics that may be gaining momentum.

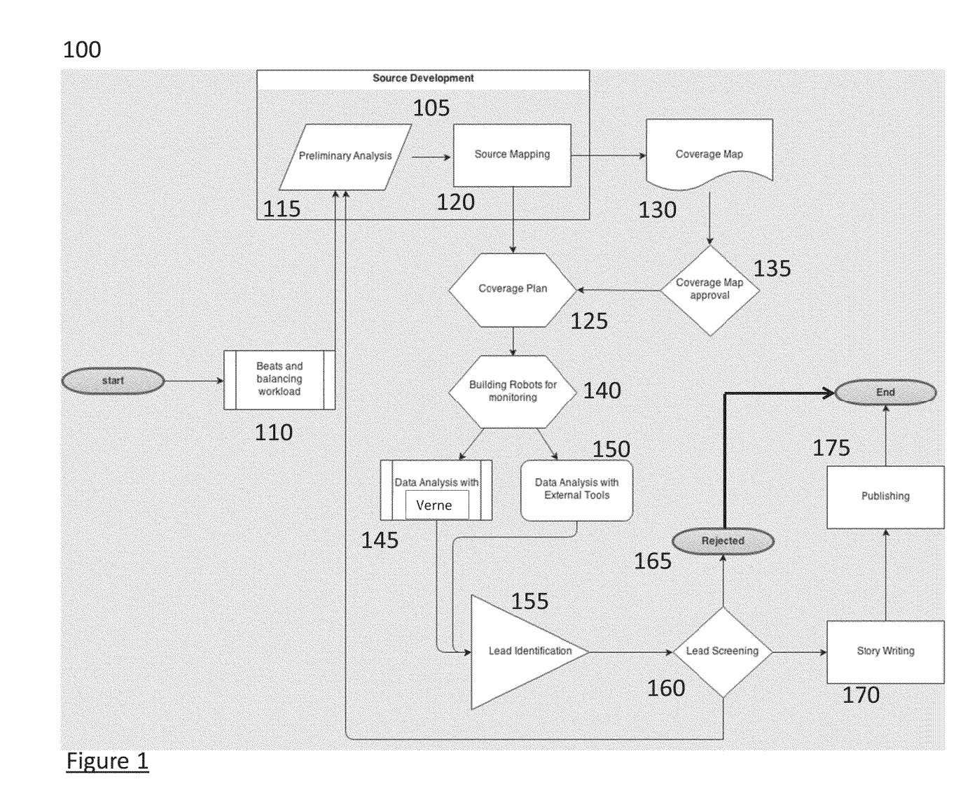

An embodiment may be a process, where such process may be iterative and combine SAs, Editors and Journalists, and/or Video producers. With reference to FIG. 1, a process 100 may start with preliminary research and may build a coverage plan, for example to a topic and/or an area. Such process may continue until exhausting all sources, for example, in an optimized way, to discover leads (e.g. golden nuggets). Editors, journalists and/or video producers may work on such story and/or story-telling and/or a final product. In some embodiments, a procedure may support iterating back to the start in order to focus, for example, on a deeper subtopic, or an area, until a full picture may be presented.

Pre-Process—Strategic planning

A process may be based on beats structure, or an arrangement according to geographic regions. Such beats may be addressed by a group comprising: (1) one or more editors; (2) one or more journalists; and/or (3) one or more SAs. Others may also form a part of such group.

A beat may be addressed by an SA that may be both an expert in deep web analysis and also with skill related to the beat. For example, SAs in the “world beat” may have linguistics skills. An SA team leader may be in charge of building beats with a managing editor, for example in such a way that a workload may remain balanced 110 among SAs.

An SA team lead may lead such a process with a strategic planner, who may be in charge of, for example, pointing out directions, topics, trends, sources, and/or technology that may be covered and/or explored.

In an embodiment, in order to be current, or stay on top of, news, a strategic planner may lead such a process on a periodic basis, e.g. an ongoing weekly cycle, and may send, for example “items on the radar”, e.g. topics that may not be covered at a present time but may be covered at a future time. Such topics may be noticed by noting a gaining popularity, for example by monitoring social activity, e.g. on the Internet and/or via Internet-connected applications. An editor may decide whether there may be a desire to start building a coverage plan, e.g. ad hoc, long term, or another method, for such topics, events and/or areas.

Source Development

Source development may be a process of finding different deep web sources to monitor, for example for a specific case or news item.

Source development 105 may vary among different online sources and/or topics.

An understanding of a topic and/or area being covered may be developed, and may be a preliminary analysis 115. For example, if covering Egypt, research of an Egyptian web industry and/or behavior may be developed. Such development may be by detecting relevant social networks, website, applications (apps), online tools and/or other items, being used in Egypt. Results of such preliminary research may lead to, for example, a different source development and/or coverage plan. For a particular event, e.g. an Egyptian protest, for example, an Internet application, e.g. Facebook, Twitter, etc., may be reviewed, monitored and/or covered. If an event may be spread over a large geographic area, for example for a worldwide organized hacking event, Internet Relay Chat (IRC) chats may be reviewed, monitored and/or covered. Performing such preliminary analysis 115 may be a major differentiator between the present invention and other techniques.

Following preliminary analysis 115, behavior of a target may be mapped, and may be referred to as source mapping 120. Source development may be performed per source. Source development may be performed on one or more sources, e.g. social networks, blogs, communities, online tools, online databases, sensors and associated data streams, geo-based source development and/or other sources. Social networks may be any network-connected social community, e.g. Facebook, including Profiles, Groups, Events and/or Pages, Twitter, including Usernames, Hashtags, Keywords, etc., vkontakte, Weibo, etc. Blogs may include any network or Internet published writings. Communities may be discussion forums, e.g. meetups, reddit, quora, etc. Online tools and online databases may be any tools and/or databases that may be network or Internet connected. Sensors and associated data streams may send and/or receive data via a network or the Internet. Geographically based source development may use tools, e.g. proprietary tools or other tools, for geo fencing, e.g. encircling an area or geographic region, and getting relevant data associated with such area.

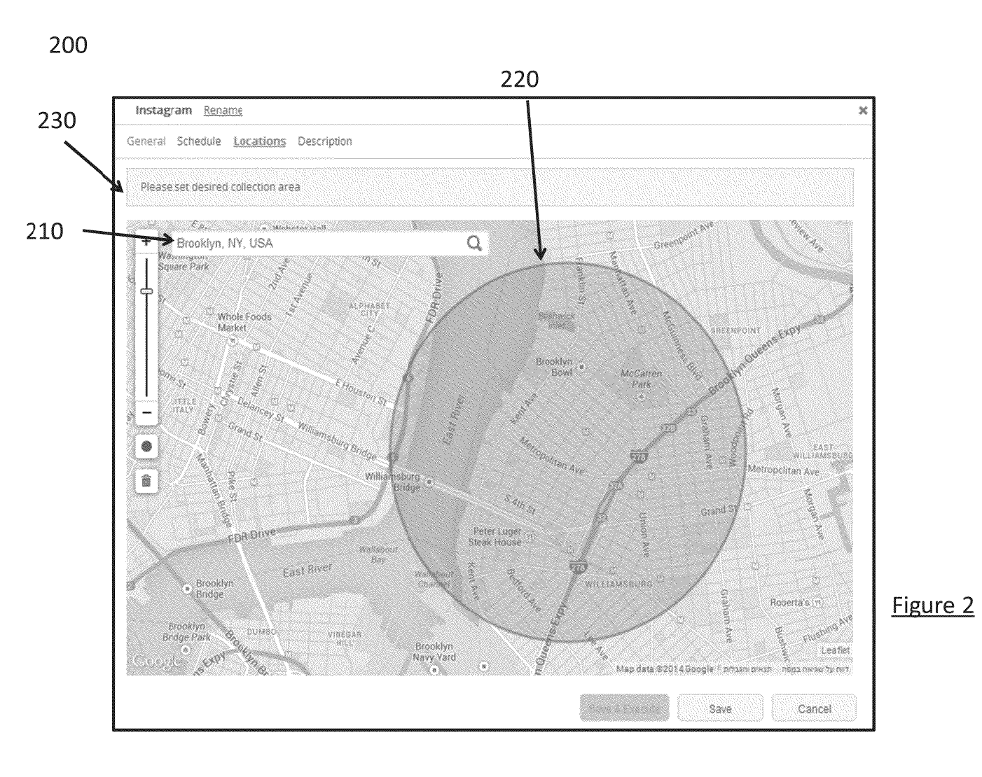

Embodiments may use one or more geographically based source development tools. For example, with reference to FIG. 2, a geographic area 200 may be identified. Such an area 200 may have a name 210 or other identifier. When such a geographically based source displays an area, a prompt 230 may be displayed to set an area 220. Area 220 may be designated or selected by a user, SA, editor, etc. Once area 220 may be selected, it may be referred to as a coverage map 130. Coverage map 130 may be approved 135. Such approval may be by an editor, etc.

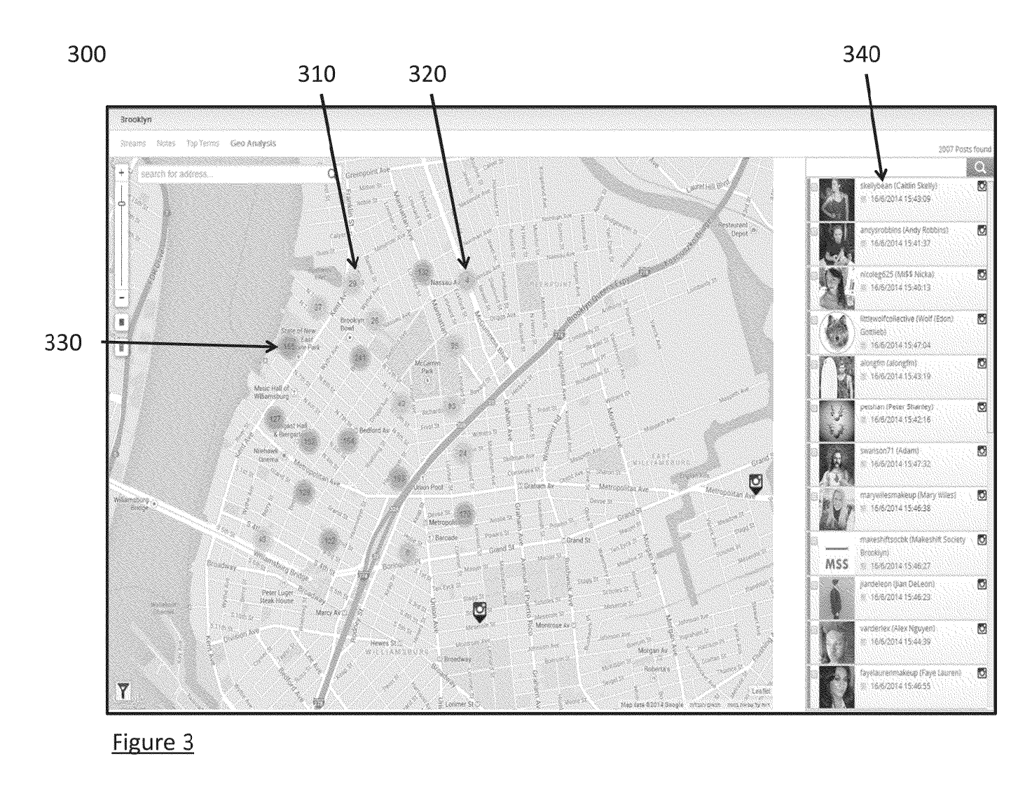

According to an embodiment, with reference to FIG. 3, an area 300 that may have been designated may be monitored. Within such area 300, using a network tool, for example by monitoring the Internet and geo-locating people within designated area 220, numbers of people expressing interest in a selected topic 310, 320 and 330 may be identified and tracked. In some embodiments, such people may be monitored according to numbers expressing interest in such selected topic and for a sub-divided geographic area. For example, within area 220, sub-regions 310, 320 and 330 may each be identified where each sub-region has different numbers of people having interest in a particular topic, according to activity from monitoring Internet activity, e.g. using a particular network tool. Sub-regions may be identified and/or designated according to numbers of people, or levels of numbers of people, e.g. designated by a color code, showing interest in a topic. A display of people commenting 340 on a topic may be identified and/or shown. Such display of people 340 may be from a single source or may be from multiple sources. Each person within display 340 may also show associated identifying information, e.g. username, specific address, associated picture, etc.

Different source development tools may be used for different sources. Some may be proprietary and others may be external tools. Tools may be used independently or multiple tools used together.

Coverage Plan

Following a sorting of source and data channels, a coverage plan 125 is constructed by experts, e.g. SA's, of how to cover each source and data channel, such that the plan may supply relevant data to cover a topic, an area or a combination of both.

Such a plan may be comprised of: a source, a definition, links to the source, an explanation of how to cover the source, e.g. login to Facebook to find X, use a robot to do Y, use OM to cover forum Z, etc, a frequency of coverage, e.g. when to sample each source and rules and alerts, e.g. what may be expected of alerts, what may be a normal behavior and what may deserve attention.

A coverage plan may be approved by an SA team lead who may make sure it is aligned with a beat strategy that may be set with an editor leading the beat. A coverage plan may be reviewed periodically, for example to fine tune and/or adjust it according to a beat's needs. Coverage plans may be kept for future reviews, project debriefings and/or educational purposes. A process of building a coverage plan may require time, e.g. several days, weeks, etc., and may depend on a complexity of the topic covered and/or a magnitude of the project. A coverage plan may have a purpose to design a monitoring stage such that monitoring of the most relevant information for what may be going on, for example on the ground, or in the field, e.g. a field of coverage.

Building Robots for Monitoring

An SA may build the monitoring according to the coverage plan. Such monitoring may be based on building robots 140, for example using a system, e.g. Verne. A robot may be a program customized according to a set of rules that may be pre-determined. A robot may operate to search a network, e.g. the Internet, and retrieve information according to such rules.

Robots may be special. Such special robots may have an SA build a designated robot, for example using an internal tool, e.g. Robot Studio. Such a tool may allow a trained analyst, for example with no experience coding language, to build automatic Internet and/or web based robots for creating data sets. Such a robot studio may require minimal training and may be highly customizable, for example by a user or an SA. A majority of the monitoring may be automatic. Data may be collected and/or stored in the news system.

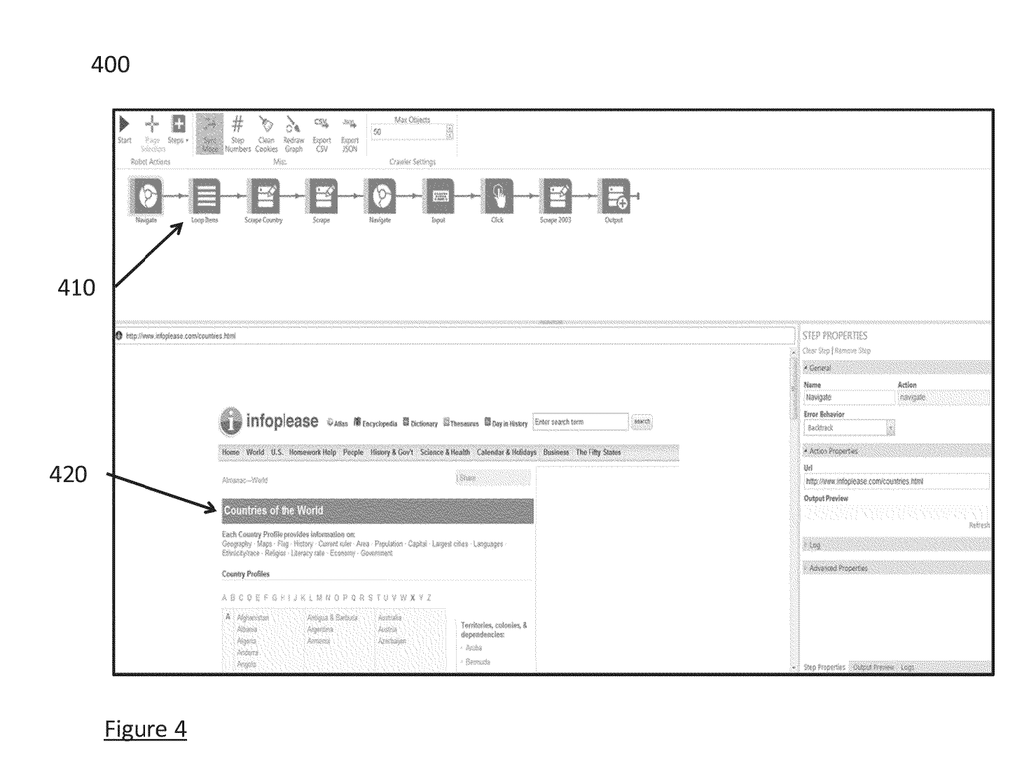

FIG. 4 depicts an exemplary display 400 of a robot 410 and information gathered 420 by such robot 410. Robot 410 may be represented by a series of actions, or commands, where such commands may comprise a robot's 410 sequence of programming steps. Such steps may be executed by a computer, or other computational device. Information returned 420 may be returned to a user, e.g. an SA, who then may take action depending on such returned information 420. Commands may be stored in a non-transitory computer readable medium.

Data Analysis

Data Analysis may be performed by a tool, e.g. Verne 145, where such tool may be a program designed and run for data analysis, or may be a tool with multiple functionalities including data analysis. Data collected by Verne may be stored in a system for future analysis and also may be used for real time alerts. A system may automatically provide notification when there may be a change in a topic or area being covered. Such a change may be a topical substantive change, a social response change within a geographical area, a redistribution of a social response among geographical sub-areas within a geographical area or other changes. A system may also perform an analysis that may allow SAs to save time by not going over all the collected data, but only the important and relevant data points. Such a process may be performed by certain models. Some exemplary models of some embodiments are described herein.

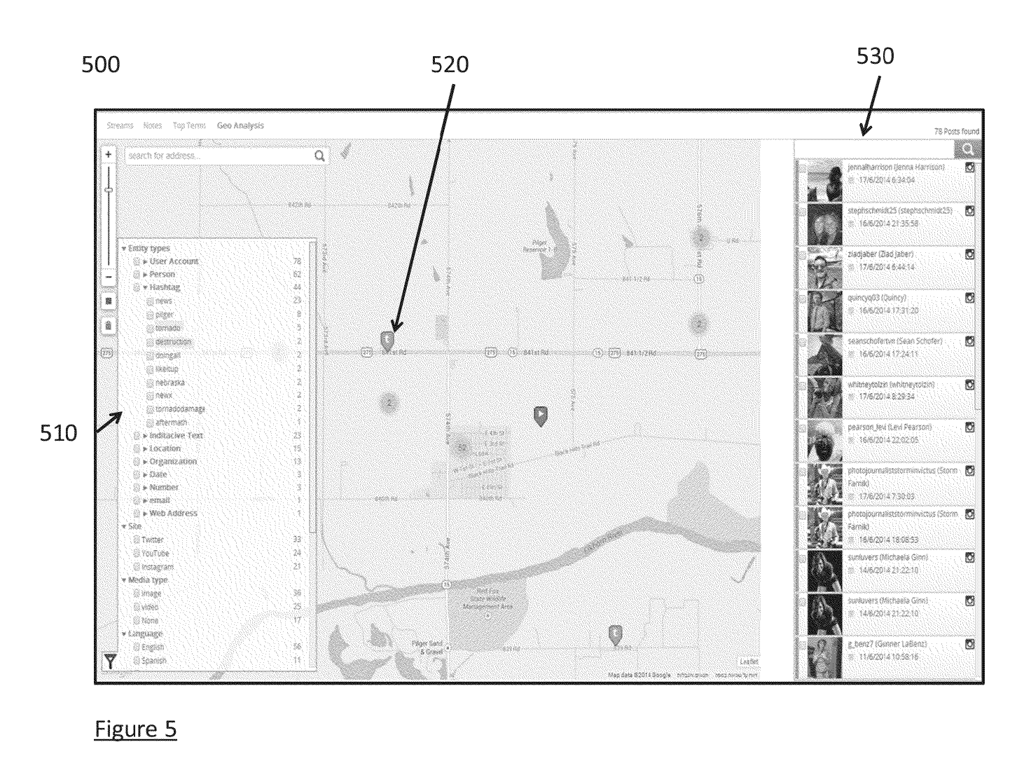

An exemplary model may be automatic entity extraction. A system may have an internal entity extraction engine that may identify entities within the data. Different posts, e.g. data points, may be clustered for filtering. An SA may use such analysis to identify important entities for investigation. FIG. 5 depicts an example of how entity extraction and filtering may show what people may be talking about in an area 500. A location 520 of one or more such people may be identified, and may also identify a medium which such person or people may be using for expression. A listing 510 may be provided that may include supplementary information, for example entity types, e.g. user account, person, hashtag, location, organization, date, number, email, web address, site, media type, language, etc. Such supplementary information may be used for data analysis. A display of people commenting 530 on a topic may be identified and/or shown. Such display of people 530 may be from a single source or may be from multiple sources. Each person within display 530 may also show associated identifying information, e.g. username, specific address, associated picture, etc.

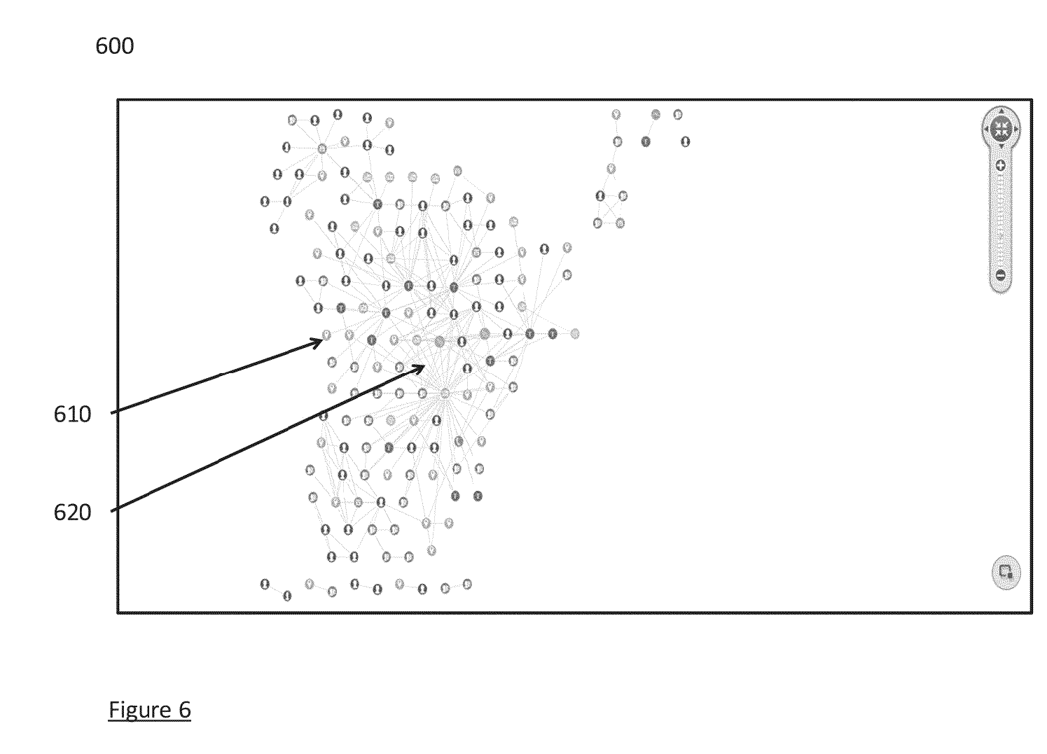

An exemplary model may be Visual Link Analysis (VLA). With reference to FIG. 6, a map 600 of substantially all of the entities collected by the system for a topic and/or time period may be displayed. A tool, e.g. Verne, may identify connections 620 between entities 610 and weigh them according to frequency. SAs may use such a map to identity important entities within the data, and such identification may be performed without reading the posts themselves. As such, efficiency may be gained. Map 600 may be filtered, for example by weight, where weight may be defined by a frequency of activity or by another metric.

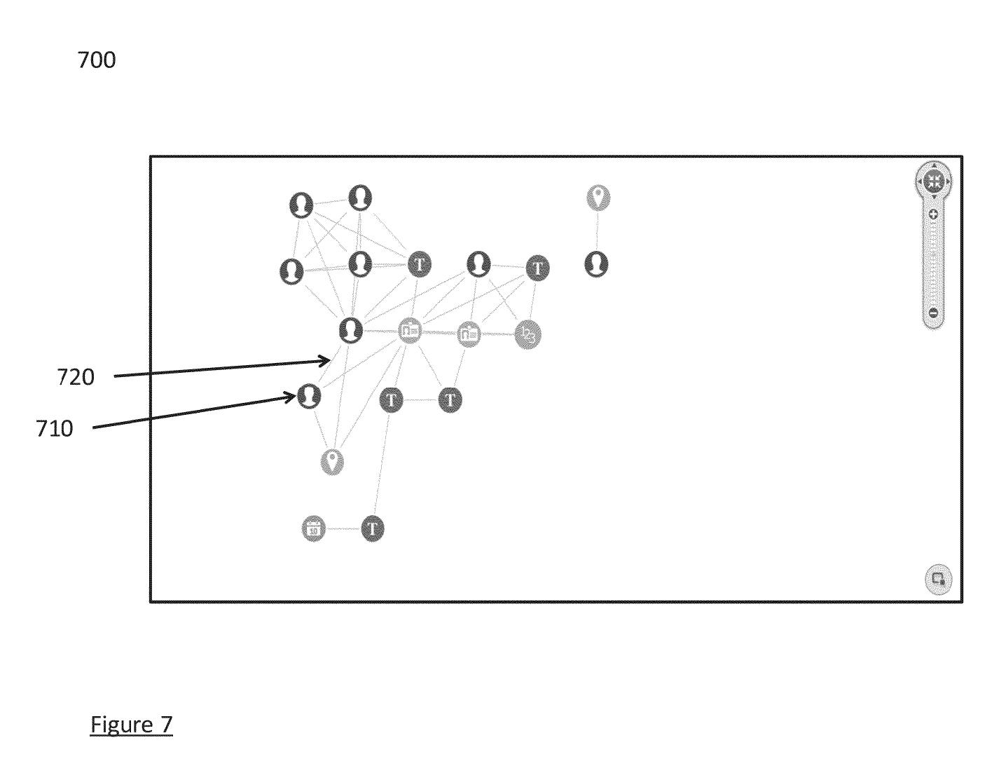

With reference to FIG. 7, an exemplary map 700 filtered by weight may be depicted. Following such filtering, connections 720 between entities 710 may be depicted, and such filtered results may be used for data analysis. Entities 710 may be depicted by symbols that may represent categories or subsets of such entities, or people.

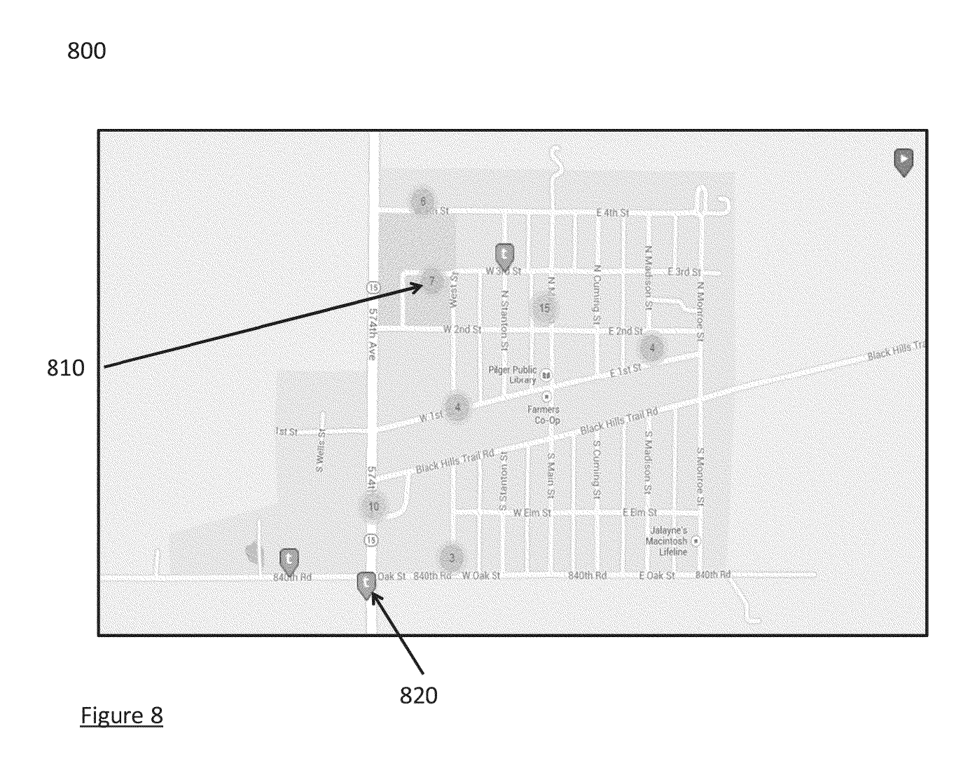

Another exemplary model may be Geo analysis, or geographically based analysis. With reference to FIG. 8, internal tools may geo tag data collected and may present such tagged data on a map 800. Analysts may then use map 800 to focus on important areas, or areas designated to be of interest, and to understand a monitored territory better. Entities 820 may be identified geographically and by a medium of communication, for example as represented by a symbol. Collections, or concentrations, of people interacting about a selected topic 810 may be identified geographically on map 800, and a number may be displayed that may correlate to a number of people included in such interactions.

Data Analysis With External Tools

Data analysis may be performed by tools, for example tools that may be external tools 150. External tools may be, for example, tools an analyst may use, including robot studio, manual monitoring or other external tools for monitoring of data. Data collected may or may not be stored in an internal system, e.g. Verne, and may allow for development of a different analysis. In such cases an analysis may be performed using other tools, e.g. Microsoft Excel files, using R scripting language or other tools or combinations of tools. Data analysis may be performed by both an internal system, e.g. Verne 145, and one or more external tools 150.

Lead Identification

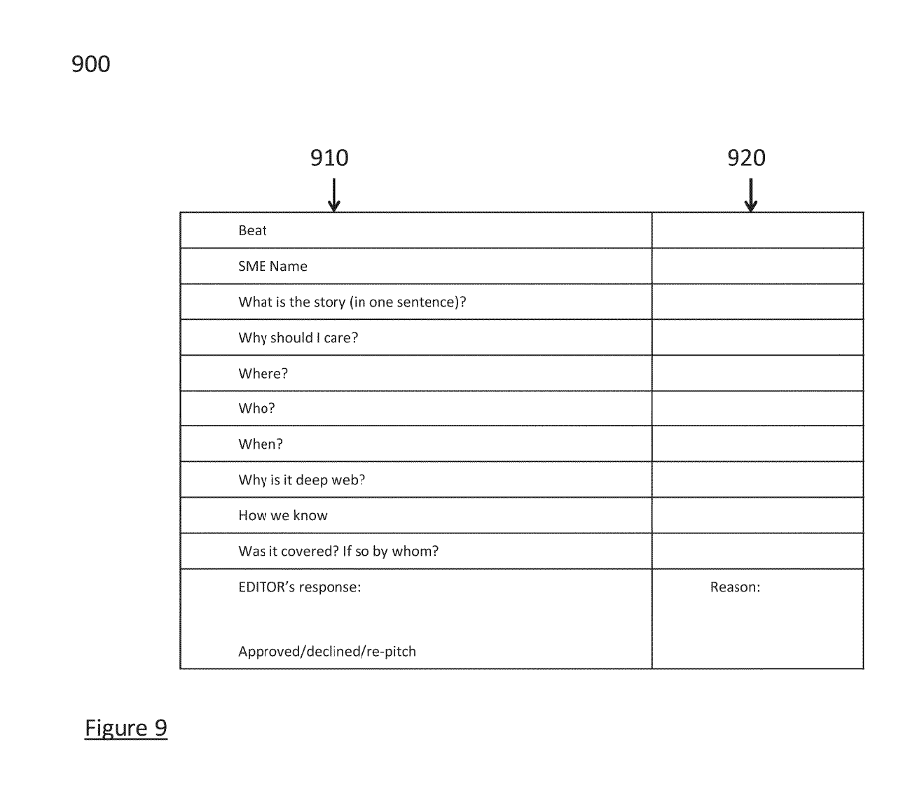

After analyzing data gathered, an SA may collect the leads, e.g. “Golden nuggets”, for example, according to a beat's plan, ongoing discussion with a beats' editors, journalists and an SA team lead, and such leads may be identified 155. With reference to FIG. 9, such leads may then be sent, for example using a format 900. A format 900 may include a listing of identifying or categorizing titles 910 and corresponding information 920 specific to a lead. Leads may be sent periodically, e.g. every day, and may include such a format 900. A discussion may occur among an editorial team, and such discussion may occur according to the periodicity of which leads may be sent. In certain cases where response time may be critical or may require shortening, e.g. for a breaking news story, for time sensitive leads, etc., SAs may report in real-time, or live, to an editor.

Lead Screening

In an embodiment, editors may receive leads and may screen leads 160 periodically, for example on a daily basis. Leads may be rejected 165 or approved. Leads that may be approved may be approved for writing, approved for further analysis or approved for development of a new angle, or story perspective. Leads that may be rejected 165 may be subject to a debriefing that may be performed, for example for internal education and/or process optimization. Leads that may be approved for writing may be assigned to a journalist, who may then work on the lead, for example with an SA, to develop a story using such lead, and perform story writing 170. Leads that may be approved for further analysis may undergo a second iteration, for example by returning to preliminary analysis 115. A lead may not be ready for a story. An SA may discuss a lead with an editor, and together it may be decided about an angle for research that may be taken for a next iteration. Such a lead may return to source development 105, for example under new objectives or assumptions. Leads that may be approved for a new angle may undergo a second iteration. A lead may not be good enough for analysis; however a new angle or perspective may be researched. An SA may discuss a lead with an editor, and together it may be decided about an angle for research that may be taken for a next iteration. Such a lead may return to source development 105, for example under new objectives or assumptions.

Story Writing

Stories that may be assigned to a journalist may be in the writing phase, or at story writing 170. An SA may work with a journalist to lay or define a storyline, collect evidence, e.g. media, web posts, documents, etc., and may supply complementary objects to the story, e.g. translations, charts and/or other data visualization. Both an SA and a journalist may work together, for example with different functions according to a team shape and may create the story. Other functions, for example data editors, data scientists, photo-desk and/or interactive designers, may also be involved. An SA may compile a list of relevant data that may have been pulled from the system for archiving, optimization, legal and/or other reasons and functions.

Publishing

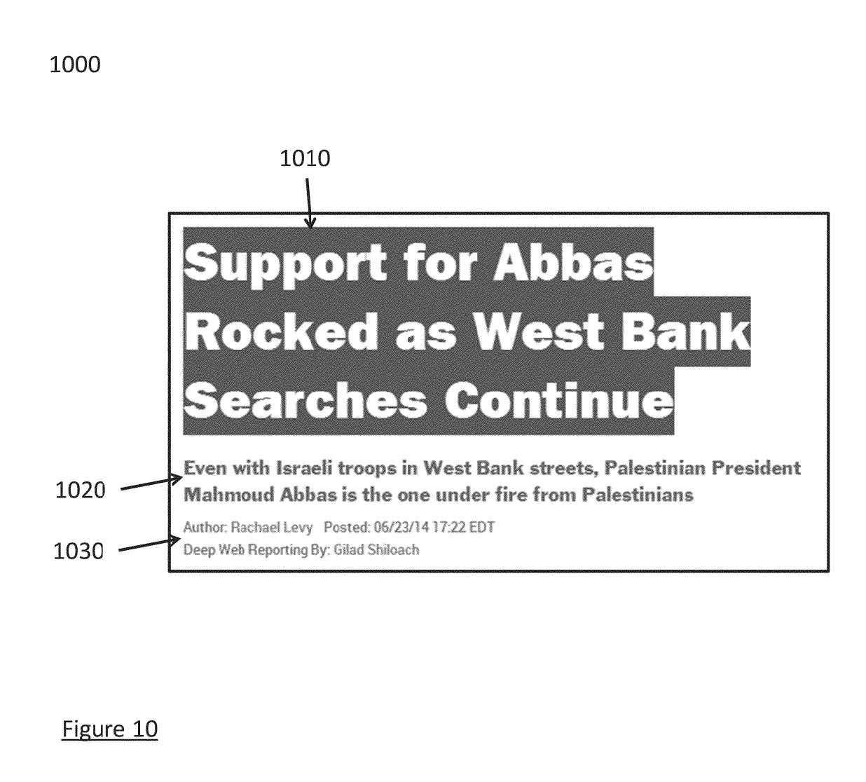

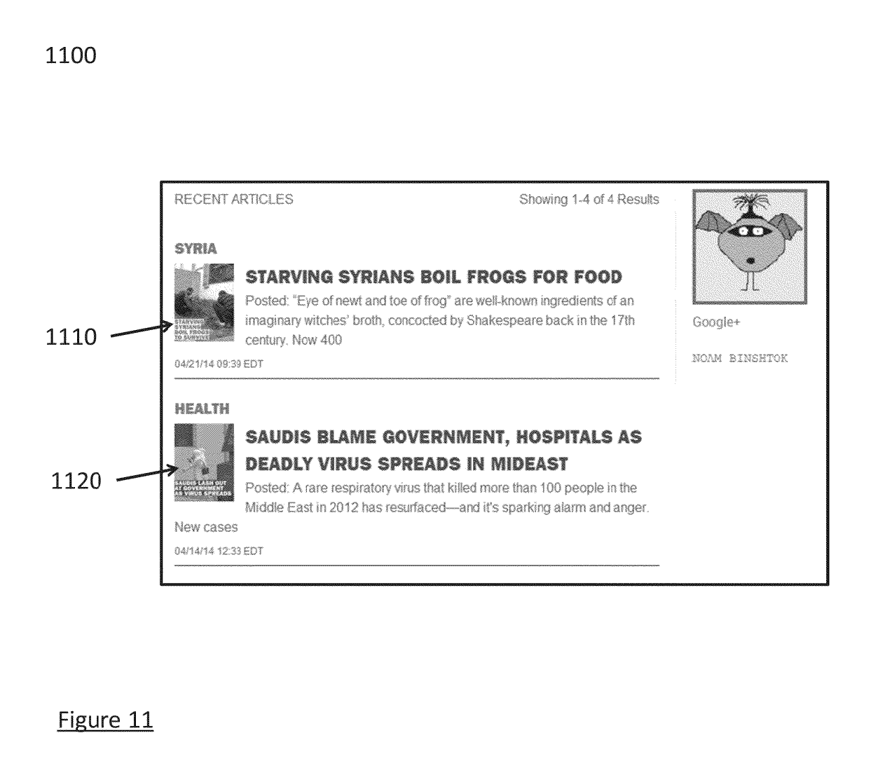

A story may be published 175, for example on a website, e.g. Vocativ website, or another website, e.g. a Vocativ partner properties (web and/or TV) while giving credit, e.g. a byline, to both a journalist and an SA. With reference to FIG. 10, an exemplary published header 1000 may be depicted. A story title 1010, a header line 1020 and bylines 1030 may be included. Bylines 1030 may include an author's name, an SA's name, a date of publication, a time of publication and/or other information. As with a journalist, an SA may have a profile page that may include stories he or she may have contributed to, for example for accountability, recognition, etc. With reference to FIG. 11, an exemplary listing of articles to which an SA has contributed 1100 may be depicted. A first article 1110 may be listed, and may include such information as a general topic or category, a title, a header line, a date of publication, a time of publication, etc. A second article 1120 may be listed depicting similar information. Additional articles may be listed. Articles may be listed in an order, for example with the most recent article listed first and in order of publication date.

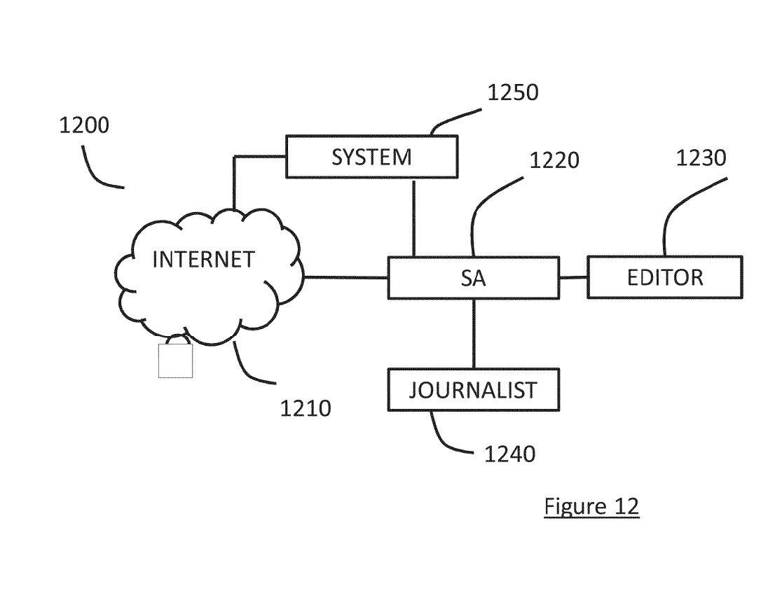

Reference is made to FIG. 12, which is a system 1200 according to embodiments of the present invention. A non-transitory computer based system 1250 for news gathering and monitoring, and on-line publication of a journalistic story may be part of system 1200. System 1250 may be operably connected to the Internet 1210, or another network.

System 1250 may be any suitable computer or computing device. System 1250 may be used to execute any computations or analysis according to embodiments of the present invention. System 1250 may be a stand-alone computing device or may be contained within other computing or multi-functional devices. System 1250 may be operably connected to the Internet 1210 or another network, where such connection may be wired, wireless or any other operably connection. System 1250 may include a display unit and/or other interface or input units. System 1250 may comprise a computer readable medium further comprising instructions which when implemented in one or more processors in a computing system cause the system to implement all or part of methods of embodiments described herein.

A Sensing Analyst 1220 may use a computer based system to perform source development around beats, define a coverage map for monitoring a source, contribute to a coverage plan of a beat and a coverage map, receive data from robots, where robots monitor sources within a coverage map and gather news data according to a coverage plan, use tools based within a computer based system to analyze data and create leads, contribute to screening leads according to a coverage plan and contribute to a journalistic story. SA 1220 may also perform research and other functions using the Internet 1210. An editor 1230 may interact with an SA and assign a beat, create a coverage plan and screen leads. A journalist 1240 may write a journalistic story based on screened leads and Sensing Analyst inputs.

An embodiment may be a method for gathering and publishing news comprising assigning a beat, performing source development around these beats, defining a coverage map for monitoring a source, creating a coverage plan of a beat and a coverage map, receiving data from robots, where robots are predetermined programs, or computer based instruction sets, to monitor sources within a coverage map and gather news data according to a coverage plan, using tools to analyze the data and create leads, screen leads according to a coverage plan, compose a journalistic story based on the screened leads and publish the story. Assigning a beat may be providing input to a computer or computational device to define assignment of a beat. Source development may be performed by a computer and/or a computational device. Defining a coverage map may be by providing input to a computer or computational device to define a coverage map. Creating a coverage plan may be a computational device receiving input or inputs that may define a coverage plan. Receiving data from robots may occur within a computer or computational device, or among multiple computers and/or computational devices, and may be a transfer of data from programs, e.g. robots, to other programs, e.g. analysis programs or data analysis programs. Monitoring of sources may be by executing commands, e.g. via a program, that may be running on a computer or computational device. Gathering news data may be by input to a computer or computational device, and may be by a user interface device or automatically according to a predetermined instruction set. Tools to analyze data and/or create leads may be predetermined programs that may be executing on a computer or computational device. Screening leads according to a coverage plan may be performed by displaying information on a display device and waiting for user input via a user input device, automatically via a set of predetermined instructions, or a combination of both. Screened leads may be presented on a display device and may be used by a user to compose a journalistic story using one or more input devices, where such story may be stored in a memory that may be operably connected to a computer or computational device. A story may be published by using a computer or computational device that may be connected to a network, e.g. the Internet, to display the contents of the story to one or more users via one or more display devices, or may be stored in an operably connected memory for future display. A story may be an output of the method described herein, and may be based on inputs described herein, modified according to one or more methods described herein. References to people may be considered to be input from one or more categorized users via a user input device, to one or more computers or computational devices. Computers and/or computational devices described herein refer to non-transitory computers or non-transitory computer devices, and may be operably coupled to one or more memories, networks, user input devices and/or display devices. Additionally, a beat may be a geographically based journalistic topic, a geographic region, a subject matter or set of subject matters, a journalistic story or set of related stories, any set of topics that may be considered to be newsworthy or any combination thereof. Also, source development may comprise preliminary analysis of a beat, and may comprise source mapping of sources contributing to a beat, and/or a source may be a person, for example posting to an on-line community. Source development may also be performed by a Sensing Analyst. A coverage map may be selected by a Sensing Analyst. A robot may be a predetermined non-transitory computer based instruction set. A robot may be stored in a memory on a local system. A robot may be altered by a Sensing Analyst. Tools may be stored internal to a local system. Tools may also comprise data analysis software, and may be both internal to a local system and available from an on-line network. Screening of leads may be performed by a Sensing Analyst and an editor. Publishing of a story may be performed in an on-line medium. Methods herein may be computer implemented methods.

An embodiment may be a system for gathering and publishing news comprising: a non-transitory computer based system for news gathering and monitoring, and on-line electronic publication of a journalistic story, including an editor for assigning a beat, where such editor may input to such system a set of rules or instructions comprising a beat assignment, creating a coverage plan, screening leads, and storing each in a computer based system, and a Sensing Analyst to use a computer based system to perform source development around the beats, define a coverage map for monitoring said source, contribute to said coverage plan of the beat and a coverage map, where such Sensing Analyst may provide inputs to a system via a user input device for such, receive data from robots, e.g. via a display device, where robots monitor sources within a coverage map and gather news data according to a coverage plan, use tools based within a computer based system to analyze data and create leads, contribute to screening leads according to a coverage plan and contribute to a journalistic story, and a journalist to write a journalistic story based on screened leads and Sensing Analyst inputs, where such writing may be by input to a computer or computational device via a user input. A journalistic story may be published on an Internet based medium. A computer based system may further comprise a memory and a database for storage of data according to a coverage plan. A computer based system may also further comprise one or more robots for data gathering. Data may be gathered using data analysis software.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for gathering and publishing news comprising:
assigning a beat;
performing source development around said beats;
defining a coverage map for monitoring said source;
creating a coverage plan of said beat and said coverage map;
receiving data from robots, where said robots monitor said sources within said coverage map and gather news data according to said coverage plan;
using tools to analyze said data and create leads;
screen said leads according to said coverage plan;
compose a journalistic story based on said screened leads; and
publish said story.

2. The method of claim 1, wherein said beat is a geographically based journalistic topic.

3. The method of claim 1, wherein said source development comprises preliminary analysis of said beat.

4. The method of claim 1, wherein said source development comprises source mapping of sources contributing to said beat.

5. The method of claim 1, wherein said source is a person posting to an on-line community.

6. The method of claim 1, wherein said source development is performed by a Sensing Analyst.

7. The method of claim 1, wherein said coverage map is selected by a Sensing Analyst.

8. The method of claim 1, wherein said robot is a predetermined non-transitory computer based instruction set.

9. The method of claim 8, wherein said robot is stored in a memory on a local system.

10. The method of claim 8, wherein said robot is altered by a Sensing Analyst.

11. The method of claim 1, wherein said tools are stored internal to a local system.

12. The method of claim 11, wherein said tools comprise data analysis software.

13. The method of claim 1, wherein said tools are both internal to a local system and available from an on-line network.

14. The method of claim 1, wherein said screening of said leads is performed by a Sensing Analyst and an editor.

15. The method of claim 1, wherein said publishing of said story is performed in an on-line medium.

16. A system for gathering and publishing news comprising:
a non-transitory computer based system for news gathering and monitoring, and on-line electronic publication of a journalistic story;
an editor for assigning a beat, creating a coverage plan, screening leads, and storing each in said computer based system;
a Sensing Analyst to use said computer based system to perform source development around said beats, define a coverage map for monitoring said source, contribute to said coverage plan of said beat and said coverage map, receive data from robots, where said robots monitor said sources within said coverage map and gather news data according to said coverage plan, use tools based within said computer based system to analyze said data and create leads, contribute to screening said leads according to said coverage plan and contribute to a journalistic story; and
a journalist to write said journalistic story based on said screened leads and said Sensing Analyst inputs.

17. The system of claim 16, wherein said journalistic story is published on an Internet based medium.

18. The system of claim 16, wherein said computer based system further comprises a memory and a database for storage of data according to said coverage plan.

19. The system of claim 18, wherein said computer based system further comprises robots for data gathering.

20. The system of claim 16, wherein said data is gathered using data analysis software.
